(19) United States
(12) Patent Application Publication
(10) Pub. No.: US 2013/0175931 A1
(43) Pub. Date: Jul. 11, 2013

(54) Triac Dimming Control System

(71) Applicant: Laurence P. Sadwick, Salt Lake City, UT (US)

(72) Inventor: Laurence P. Sadwick, Salt Lake City, UT (US)

(21) Appl. No.: 13/734,836

(22) Filed: Jan. 4, 2013

Related U.S. Application Data
(60) Provisional application No. 61/583,256, filed on Jan. 5, 2012.

(51) Int. Cl. H05B 37/02

(52) U.S. Cl. CPC H05B 37/02
USPC 315/158; 315/209 R; 315/210

(57) ABSTRACT

A triac dimming control system processes the output of a triac based dimmer, generates a dimming control signal based on the output, and provides dimming at a load output based on the dimming control signal.

### CROSS REFERENCE TO RELATED APPLICATIONS

The present application claims priority to U.S. Patent Application No. 61/583,256 entitled “Triac Dimming Control System, filed Jan. 5, 2012, the entirety of which is incorporated herein by reference for all purposes.

### BACKGROUND

There are a large number of low cost triac based dimmers that are presently installed world wide. Such dimmers were often intended for use with incandescent light bulbs. When different loads such as more efficient light sources including light emitting diodes (LEDs) and fluorescent lamps (FLs) are installed, triac based dimmers may not give the desired results.

### SUMMARY

A triac dimming control system is disclosed which processes the output of a triac based dimmer, generates a dimming control signal based on the output, and provides dimming at a load output based on the dimming control signal. In some embodiments, the dimming control signal is a 0-10V dimming control signal. In some other embodiments, the dimming control signal is a DC dimming control signal with voltage ranges other than 0-10V.

This summary provides only a general outline of some particular embodiments. Many other objects, features, advantages and other embodiments will become more fully apparent from the following detailed description. Nothing in this document should be viewed as or considered to be limiting in any way or form.

### BRIEF DESCRIPTION OF THE DRAWINGS

A further understanding of the various exemplary embodiments may be realized by reference to the figures which are described in remaining portions of the specification. In the figures, like reference numerals may be used throughout several drawings to refer to similar components.

FIG. 1 depicts a block diagram of a triac dimming control system in accordance with some embodiments of the present invention;

FIG. 2 depicts a block diagram of a triac dimming control system with another power connection in accordance with some embodiments of the present invention;

FIG. 3 depicts a block diagram of a triac dimming control system with a secondary load to promote low current and other potentially needed triggering of the triac in accordance with some embodiments of the present invention;

FIG. 4 depicts a block diagram of a triac dimming control system with a variable secondary load to promote low current and other potentially needed triggering of the triac in accordance with some embodiments of the present invention;

FIG. 5 depicts a block diagram of a triac dimming control system with a secondary load connected in another manner to promote low current triggering of the triac in accordance with some embodiments of the present invention;

FIG. 6 depicts a block diagram of a triac dimming control system with multiple dimmable light sources in accordance with some embodiments of the present invention;

FIG. 7 depicts a block diagram of a triac dimming control system with multiple dimmable light sources and with a secondary load to, for example, promote low current triggering of the triac in accordance with some embodiments of the present invention;

FIG. 8 depicts a block diagram of a triac dimming control system with a single power connection and with a secondary load to, for example, promote low current triggering of the triac in accordance with some embodiments of the present invention;

FIG. 9 depicts a block diagram of another triac dimming control system with an external control signal and a secondary load in accordance with some embodiments of the present invention;

FIG. 10 depicts a block diagram of a triac dimming control system which converts a triac dimming output signal, powerline dimming signal or wireless dimming signal to a 0 to 10V or other analog or digital dimming control signal in accordance with some embodiments of the present invention;

FIG. 11 depicts a block diagram of another triac dimming control system which converts a triac dimming output signal, powerline dimming signal or wireless dimming signal to a 0 to 10V or other analog or digital dimming control signal in accordance with some embodiments of the present invention;

FIG. 12 depicts a block diagram of another triac dimming control system which converts a triac dimming output signal, powerline dimming signal or wireless dimming signal to a 0 to 10V or other analog or digital dimming control signal in accordance with some embodiments of the present invention;

FIG. 13 depicts a block diagram of another triac dimming control system which converts a triac dimming output signal, powerline dimming signal or wireless dimming signal to a 0 to 10V or other analog or digital dimming control signal in accordance with some embodiments of the present invention;

FIG. 14 depicts a block diagram of triac dimming control system with various control inputs and outputs in accordance with some embodiments of the present invention;

FIG. 15 depicts a comparator circuit for modifying a dimming control signal based on a photo-cell light signal in accordance with some embodiments of the present invention;

FIG. 16 depicts another comparator circuit for modifying a dimming control signal based on a photo-cell light signal in accordance with some embodiments of the present invention;

FIG. 17 depicts a circuit for modifying a dimming control signal based on a motion detector signal in accordance with some embodiments of the present invention;

FIG. 18 depicts a circuit for modifying a dimming control signal based on a motion sensor in accordance with some embodiments of the present invention;

FIG. 19 depicts another circuit for modifying a dimming control signal based on a motion sensor in accordance with some embodiments of the present invention;

FIG. 20 depicts a block diagram of a triac dimming control system with voltage reference in accordance with some embodiments of the present invention; and

FIG. 21 depicts a flow chart of an operation for generating a 0-10V dimming control signal based on an output of a triac dimmer in accordance with some embodiments of the present invention.

### DESCRIPTION

Brief definitions of terms used throughout this document are given below. The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phrases do not necessarily refer to the same embodiment.

If the specification states a component or feature “may”, “can”, “could”, or “might” be included or have a characteristic, that particular component or feature is not required to be included or have the characteristic.

A dimmer for LED drivers and other types of lighting sources is disclosed herein that can be used to provide power for lights such as LEDs of any type, including organic LEDs (OLEDs), as well as other loads, including but not limited to, fluorescent lamps (FLs) including, and also not limited to, compact fluorescent lamps (CFLs), energy efficient FLs, cold cathode FLs (CCFLs), incandescent lamps, etc. The inventions disclosed herein are not limited to the example circuits and applications illustrated, and may be adapted to use with, for example but not limited to, the circuits and applications disclosed in U.S. Patent Application 61/646,289 filed May 12, 2012 for a “Current Limiting LED Driver”, and in U.S. Pat. No. 8,148,907 issued Apr. 3, 2012 for a “Dimmable Power Supply”, which are incorporated herein by reference for all purposes.

Many dimmers currently available cause and produce flicker, flashing and other undesirable effects when used with, for example, LED lighting and LED lighting drivers. In addition, it is often difficult to dim to very low levels (i.e., deep dimming) with Triac dimmers. In certain cases there is not symmetry in the turn on and turn off characteristics. The behavior of many dimmers, including triac dimmers, are often also influenced by the impedance of the AC lines and due to, for example, other electrical devices and apparatus on the AC lines. Although dimmers exist that do not use triacs as the dimming elements and, instead, for example, use transistors and can be of either the forward type (i.e., triac waveform like—turning on after zero crossings depending on the dimming level) or the reverse type (i.e., turning on at zero crossings and then turning off depending on the dimming level), these dimmers are often expensive and have other limitations.

Dimming of lighting is important for numerous reasons and aspects including energy efficiency and meeting the needs of the users under and in various applications. Although there exist numerous dimmers for use with alternating current (AC) sources of power including many based on the use of triacs to form the active component of the dimmer, dimmers based on triacs often have negative performance aspects associated the physical principles that underlie, dictate and control the behavior of the triacs including the need for a minimum trigger current and holding current.

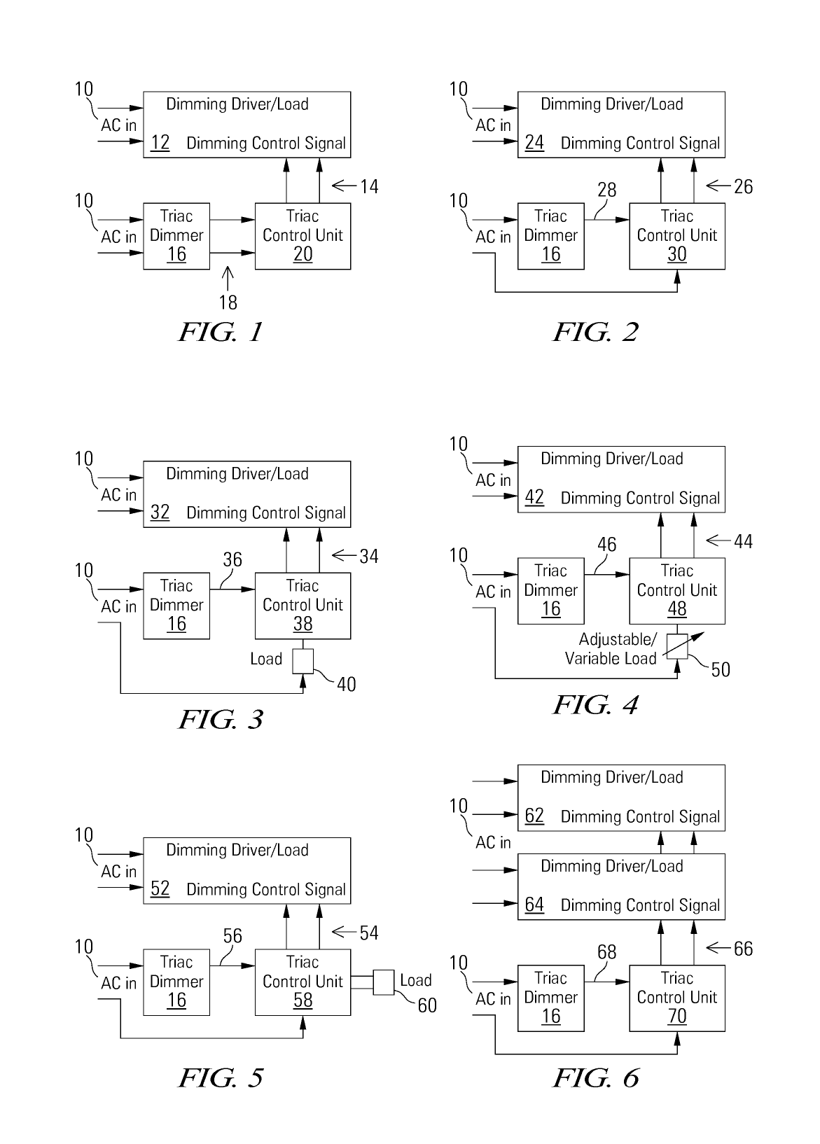

There is a need for an interface to, for example, a triac dimmer that can use the setting/dimming level from the triac dimmer to translate that setting/dimming level into, for example, an analog 0 to 10 V dimming control signal, a digital serial or parallel signal such as DMX, DALI, RS422, RS232, USB, SPI, UARTs in general, such that the dimming level from the triac is translated and applied to, for example, a dimmable driver, a dimmable ballast, a dimmable power supply, etc. An example simplified block diagram of certain embodiments of the present invention is illustrated in FIGS. 1 through 12 and an example simplified circuit translation implementation is illustrated in FIGS. 16 through 20 which may include a Zener diode, resistors or capacitors to form a zero detection/phase angle/dimming level detection circuit suitable for operation in the frequency range of 47 Hz to 63 Hz and, of course, to lower frequencies and practical useful higher frequencies. A power supply may be used to power the circuit and associated electronics, sensor, detectors, controls, monitors, interfaces, etc. The power source for the present invention can be any suitable power source including but not limited to linear regulators and/or switching power supplies and regulators, transformers, including, but not limited to, forward converters, flyback converters, buck-boost, buck, boost, boost-buck, cuk, etc. Resistors along with a Zener diode as disclosed in FIG. 23, for example, can be used to form an example zero detector/phase angle detector/converter/dimming level translator that can be either analog or digital or both in terms of the output signal provided. In some embodiments, the detection circuit is attached to the DC side of a full wave diode bridge, and other embodiments of the present invention can use for example additional components including, but not limited to, dual/AC opto-couplers/opto-isolators/etc., coils, transformers, windings, etc. The present invention is not limited to the choices discussed above and any suitable circuit, topology, design, implementation, method, approach, etc. may be used with the present invention. In addition the present invention is extremely well suited for use in both manual and automated/automatic applications including applications that utilize remote control and monitoring, energy/power control and harvesting, etc.

The present invention can be adjusted for, for example, 60 Hz or 50 Hz operation and can be selected by a number of methods including fixed, switch-selectable, automatic, auto-detect, manually set, auto-set, fixed/set for 50 Hz operation, fixed/set for 60 Hz operation, etc. Many of the embodiments of the present invention may operate in a variety of different environments and do not need to have the input frequency set for operation. Although two passive elements are shown, in general any number of resistors and/or capacitors, N, where N is equal to or greater than 1, can be used for the present invention. In addition, other implementations and embodiments of the present invention can be realized.

The present invention works for both forward and reverse dimming and dimmers including, but not limited to, triac forward dimmers.

Any suitable switch or switch-like circuit including any suitable transistor including, but not limited to, bipolar junction transistor (BJT), field effect transistor (FET), junction FET (JFET), unijunction FET (UFET), metal emitter semiconductor (MESFET), etc. can be used with the present invention.

The switch circuit may contain other elements and components, including, for example, but not limited to, diodes and diode bridges.

FIG. 1 depicts a block diagram of certain embodiments of the present invention in which a triac dimmer 16 or other type of forward or reverse AC dimmer is fed to a control unit 20 which processes and supplies an appropriate output signal or dimming control signal 14 based on the dimming information/phase angle/etc. provided in a triac dimming signal 18 by the triac dimmer 16 or other types of forward or reverse dimmer. In some embodiments, the control unit 20 is a 0 to 10 V signal proportional to the triac dimming signal 18, in other words, to the output of the triac or other types of forward or reverse dimmer dimming phase angle/dimming level, duty cycle, etc. from the triac dimmer 16. The dimming control signal 14 is supplied to a dimmable driver/load 12, which in various embodiments comprises a dimmable driver, ballast or power supply, etc. which, for example, could be a 0 to 10 V dimmable LED driver or FL ballast. Other voltage ranges such as 0 to 5 V, 0 to 2.5 V, 0 to 2 V, 0 to 1 V, etc. can be used instead of or besides the 0 to 10 V signal described above. The triac dimmer 16 and dimmable driver/load 12 are powered by an AC input 10 that may be connected as disclosed in FIG. 1 or in other manners.

FIG. 2 depicts a block diagram of certain embodiments of the present invention with alternative wiring in which a triac dimmer 16 or other type of forward or reverse AC dimmer is fed to a control unit 30 which processes and supplies an appropriate dimming control signal 26 based on the dimming information/phase angle/etc. in the triac dimming signal 28 provided by the triac dimmer 16 or other types of forward or reverse dimmer. In the system disclosed in FIG. 2, a return line of the AC input 10 is connected directly to the control unit 30, for the triac dimming signal 28. The dimming control signal 26 is supplied to a dimmable driver/load 24, which in various embodiments comprises a dimmable driver, ballast or power supply, etc. which, for example, could be a 0 to 10 V dimmable LED driver or FL ballast. Other voltage ranges such as 0 to 5 V, 0 to 2.5 V, 0 to 2 V, 0 to 1 V, etc. can be used instead of or besides the 0 to 10 V signal described above.

FIG. 3 depicts a block diagram of some embodiments of the present invention in which a secondary load 40 is connected in series with the triac dimmer 16. The secondary load 40 facilitates proper operation of the triac dimmer 16, for example assisting it to trigger at low current or low dimming angles. The secondary load 40 may be connected to the triac dimmer 16 at any suitable location in the system. The controller in conjunction with the load can provide sufficient load to and for the triac to ensure smooth and proper operation. The triac dimming signal 36 from the triac dimmer 16 is provided to a control unit 38 which processes the triac dimming signal 36 from the triac dimmer 16 to generate a dimming control signal 34 such as a 0 to 10 V control signal. Other voltage ranges such as 0 to 5 V, 0 to 2.5 V, 0 to 2 V, 0 to 1 V, etc. or other types of control signal can be used instead of or besides the 0 to 10 V signal described above. The dimming control signal 34 is provided to a dimmable driver/load 32 which in various embodiments comprises a dimmable driver, ballast or power supply, etc. which, for example, could be a 0 to 10 V dimmable LED driver or FL ballast.

FIG. 4 depicts a block diagram of some embodiments of the present invention in which a variable secondary load 50, having a variable impedance, is connected in series with the triac dimmer 16. The variable secondary load 50 facilitates proper operation of the triac dimmer 16, for example assisting it to trigger at adjustable current or dimming levels. The variable secondary load 50 may be connected to the triac dimmer 16 at any suitable location in the system. The triac dimming signal 46 from the triac dimmer 16 is provided to a control unit 48 which processes the triac dimming signal 46 from the triac dimmer 16 to generate a dimming control signal 44 such as a 0 to 10 V control signal. Other voltage ranges such as 0 to 5 V, 0 to 2.5 V, 0 to 2 V, 0 to 1 V, etc. or other types of control signal can be used instead of or besides the 0 to 10 V signal described above. The dimming control signal 44 is provided to a dimmable driver/load 42 which in various embodiments comprises a dimmable driver, ballast or power supply, etc. which, for example, could be a 0 to 10 V dimmable LED driver or FL ballast.

FIG. 5 depicts a block diagram of some embodiments of the present invention in which a secondary load 60 is connected to the control unit 58. The secondary load 60 facilitates proper operation of the triac dimmer 16, for example assisting it to trigger at low current or low dimming angles. The secondary load 60 can be driven directly by AC or rectified and driven by DC. The triac dimming signal 56 from the triac dimmer 16 is provided to the control unit 58 which processes the triac dimming signal 56 from the triac dimmer 16 to generate a dimming control signal 54 such as a 0 to 10 V control signal. Other voltage ranges such as 0 to 5 V, 0 to 2.5 V, 0 to 2 V, 0 to 1 V, etc. or other types of control signal can be used instead of or besides the 0 to 10 V signal described above. The dimming control signal 54 is provided to a dimmable driver/load 52 which in various embodiments comprises a dimmable driver, ballast or power supply, etc. which, for example, could be a 0 to 10 V dimmable LED driver or FL ballast.

FIG. 6 depicts a block diagram of some embodiments of the present invention in which a triac dimming signal 68 from a triac dimmer 16 or other type of forward or reverse AC dimmer is fed to a control unit 70 which processes and supplies an appropriate dimming control signal 66 based on the dimming information/phase angle/etc. in the triac dimming signal 68. In the embodiment of FIG. 6, the dimming control signal 66 is supplied to multiple dimmable drivers/loads 62 and 64, which in various embodiments comprise dimmable drivers, ballasts or power supplies, etc. which, for example, could be a 0 to 10 V dimmable LED drivers or FL ballasts. Thus, more than one dimmable driver, ballast and/or power supply can be driven by the present invention, requiring only one control unit 70 although additional control units may be used. The control unit 70 is capable of driving N (where N is equal or greater than 1) dimmable drivers, ballasts, power supplies, etc. in any combination (e.g., two LED drivers, three ballasts, one power supply, etc.). Other voltage ranges such as 0 to 5 V, 0 to 2.5 V, 0 to 2 V, 0 to 1 V, etc. can be used instead of or besides the 0 to 10 V signal described above.

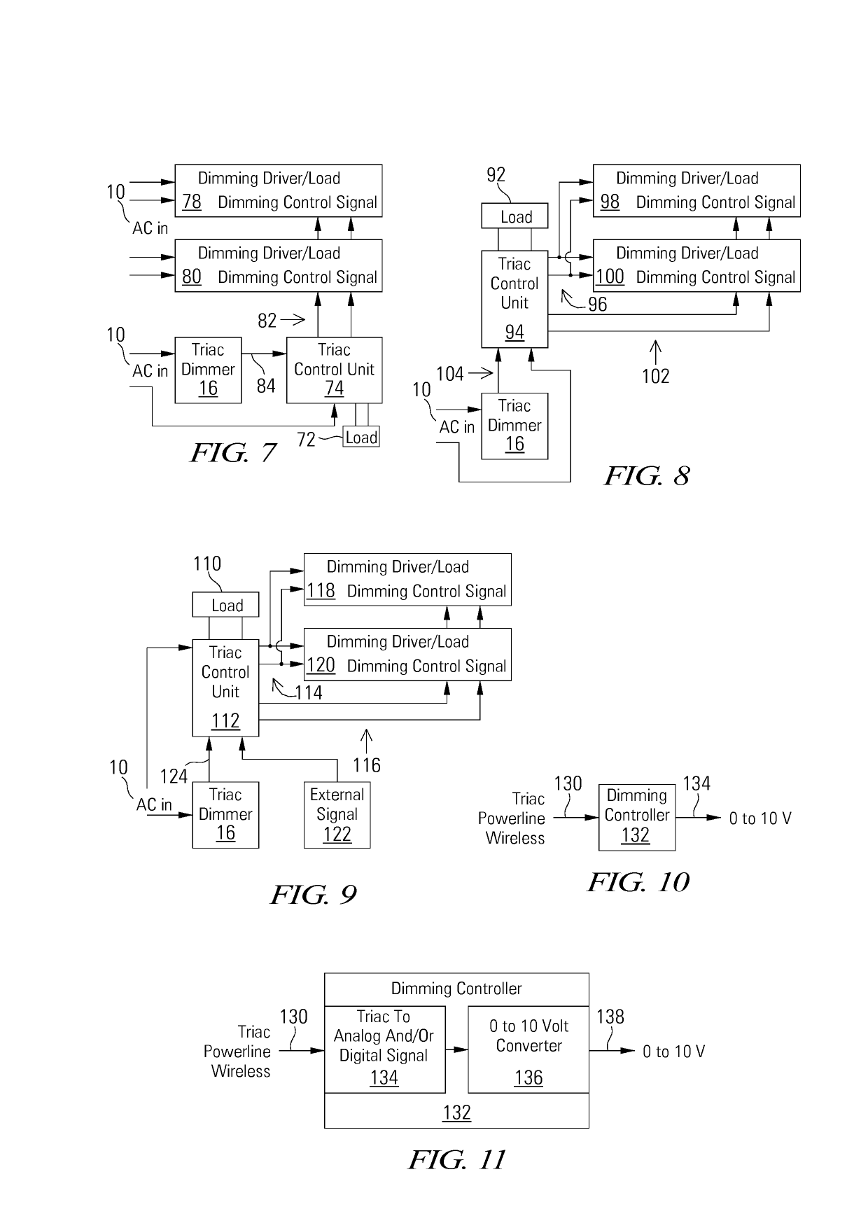

FIG. 7 depicts a block diagram of some embodiments of the present invention in which a triac dimming signal 82 from a triac dimmer 16 or other type of forward or reverse AC dimmer is fed to a control unit 74 which processes and supplies an appropriate dimming control signal 82 based on the dimming information/phase angle/etc. in the triac dimming signal 84. In the embodiment of FIG. 7, the dimming control signal 82 is supplied to multiple dimmable drivers/loads 78 and 80.

A secondary load 72 is connected to the triac dimmer 16 through the control unit 74. In many embodiments, secondary load 72 is optional. In some embodiments, secondary load 72 is a variable load. The secondary load 72 facilitates proper operation of the triac dimmer 16, for example assisting it to trigger at adjustable current or dimming levels. The secondary load 72 may be connected to the triac dimmer 16 at any suitable location in the system. Again, the secondary load 72 can be either AC or DC driven. The secondary load 72 may be, for example, an LED, organic LED (OLED), resistive, heat/thermal, incandescent, halogen, other lighting source, etc. a fan or fans, other controls, resistor(s), power supply or supplies, heaters, etc.

Turning to FIG. 8, power for some embodiments is all drawn from AC input 10 through triac dimmer 16, with power 96 provided to one or more dimmable drivers/loads 98 and 100 through control unit 94, which provides power factor correction (PFC) in some embodiments. A triac dimming signal 104 from a triac dimmer 16 or other type of forward or reverse AC dimmer is fed to the control unit 94 which processes and supplies an appropriate dimming control signal 102 based on the dimming information/phase angle/etc. in the triac dimming signal 104. A secondary load 92 is connected to the triac dimmer 16 in some embodiments, in this embodiment through control unit 94. In some embodiments, the triac can be wired in parallel with the controller and the 0 to 10 V dimmable drivers, ballasts and/or power supplies. This can allow and support, for example, retrofitting dimmable lighting solutions where either an on/off light switch (or no switch or control) existed before. Combinations of example embodiments discussed here can be used together for the present invention.

In some embodiments, control unit 94 monitors one or more signals such as input voltage current, power, power factor, etc. The control unit 94 can use this information, for example, to provide power factor correction or for other uses. In addition, the control unit can also monitor, detect, log, report, alert, respond, etc. to the input voltage, current, power, power factor, energy used/consumed/power factor (PF), etc.

The connection to AC input 10 may be performed in any suitable manner. For example, given an AC input 10 with a hot line and a neutral line, both the hot and neutral lines may pass through the triac dimmer 16 as in FIG. 1, or either the hot or neutral line may pass through the triac dimmer 16 with the other being connected directly to the control unit 94, or using any other suitable connection technique.

FIG. 9 depicts a block diagram of another triac dimming control system with an external control signal and a secondary load in accordance with some embodiments of the present invention. A triac dimming signal 124 from a triac dimmer 16 or other type of forward or reverse AC dimmer is fed to a control unit 112 which processes and supplies an appropriate dimming control signal 116 based on the dimming information/phase angle/etc. in the triac dimming signal 124. In the embodiment of FIG. 9, the dimming control signal 116 is supplied to multiple dimmable drivers/loads 118 and 120, and power 114 is provided through the control unit 112 for power factor correction or other purposes.

In some embodiments as in FIG. 9, an external control signal 122 may also be applied. The external control signal 122 may be analog, digital, frequency, DC, AC, serial, parallel, etc. More than one external control signal 122 can be included and employed. The external control signal(s) 122 can be used for a variety of uses, purposes, applications, etc. including, but not limited to, providing for dimming or to initiate download of monitoring information from the present invention. The external control signal(s) 122 can be analog or digital or both and can be two way (i.e. input and output) or just an input or an output. The external control signal(s) 122 could be wired, wireless, powerline control (PLC) etc. and could be of any suitable protocol or format. The external control signal(s) 122 could be local, global, and, for example, could come from smart grid, from web, network, bluetooth, WiFi, ZigBee, smart phone or tablet, etc. The present invention can prioritize external control signal(s) 122.

In some embodiments, a secondary load 110 is connected to the triac dimmer 16, in this embodiment through control unit 112. Some embodiments contain either the secondary load 110 or external signal 122 or both.

FIG. 10 depicts a simplified block diagram of a dimming controller 132 or interface for the present invention that takes in as an input dimming information 130 from a triac (or other type of forward or reverse dimmer), a powerline or a wireless signal and converts that signal to a dimming control signal 134 such as a 0 to 10 V signal or other analog and/or digital control signals. Other signal voltages or currents such as 0 to 5 V, 0 to 2.5 V, 0 to 2 V, 0 to 1 V, 4 to 20 mA, etc. can be used besides 0 to 10 V.

As disclosed in FIG. 11, the dimming controller 132 may include a converter 134 operable to convert a triac dimmer output to an analog and/or digital signal, and a 0 to 10 V converter 136 operable to convert the analog and/or digital signal to a 0 to 10 V dimming control signal 138 or other analog and/or digital dimming control signal used to control a voltage and/or current to a load in a dimmable driver. Other signal voltages or currents such as 0 to 5 V, 0 to 2.5 V, 0 to 2 V, 0 to 1 V, 4 to 20 mA, etc. can be used besides 0 to 10 V. Either or both the input and the output can be isolated or non-isolated using, for example, transformers, optocouplers, optoisolators, wireless transceivers, etc. The dimming controller 132 can obtain power directly from the AC lines, triac, powerline and other sources. The 0 to 10V or (other output can be isolated from the AC). The interface can use analog circuits, including but not limited to comparators, op amps, transistors, diodes, Zener diodes, etc. and/or digital circuits including but not limited to digital logic (i.e., NAND, NOR, Inverters, etc, microcontrollers, microprocessors, FPGAs, ASICs, PLDs, CLDs, digital to analog converters, analog to digital converters, etc. and can use phase detection, etc.

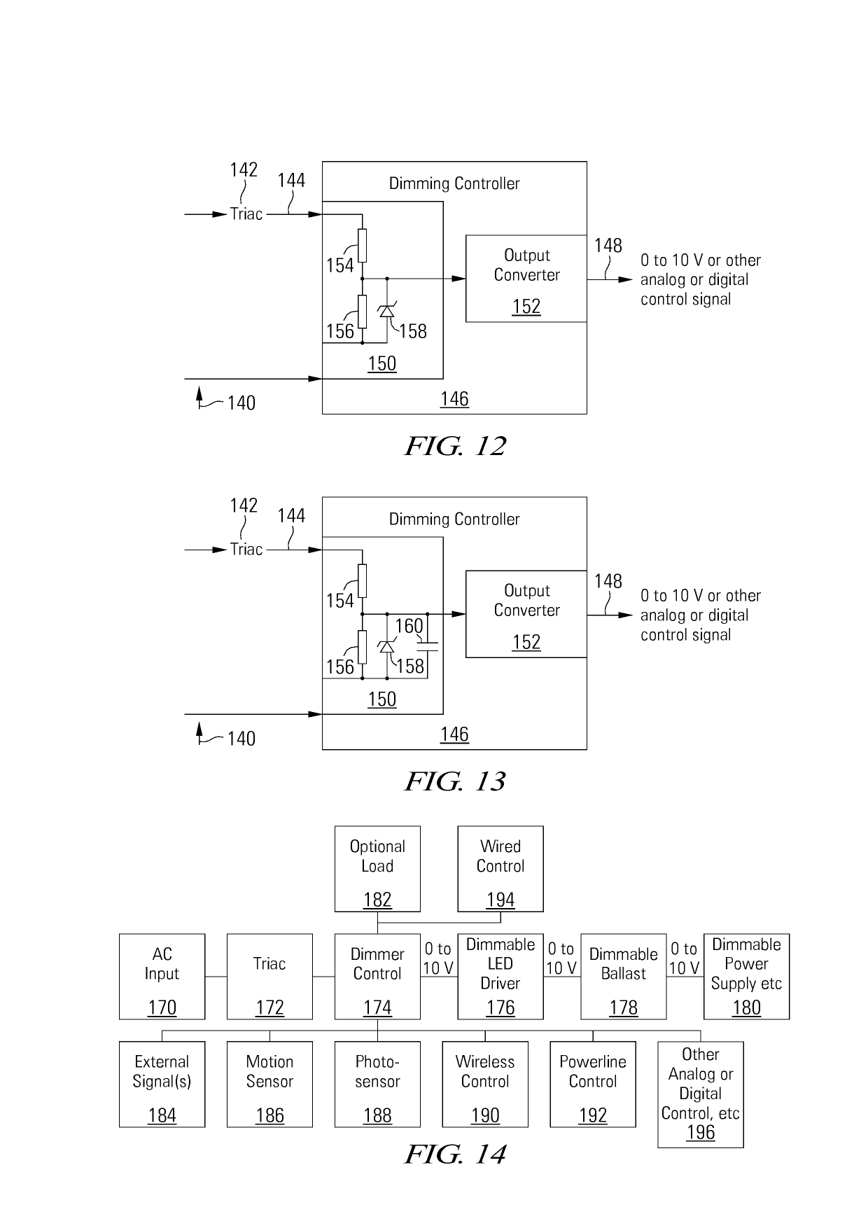

FIG. 12 depicts a block diagram of an interface or dimming controller 146, powered by an input power source 140 via a dimming signal 144 from a triac 142 or triac dimmer, and yielding a dimming control signal 148. The dimming controller 146 includes a converter 150 operable to convert a triac dimmer output to an analog and/or digital signal, and an output converter 152 operable to convert the analog and/or digital signal to a 0 to 10 V dimming control signal 148 or other analog and/or digital dimming control signal used to control a voltage and/or current to a load in a dimmable driver. Other signal voltages or currents such as 0 to 5 V, 0 to 2.5 V, 0 to 2 V, 0 to 1 V, 4 to 20 mA, etc. can be used besides 0 to 10 V.

The converter 150 includes a voltage divider made up, for example, from a pair of resistors 154 and 156 or a pair of capacitors, with a Zener diode 158 in parallel with the output of the voltage divider. The converter 150 functions as a phase detection circuit that, for example, depending on the values of the components 154, 156 and 158, can provide an analog output (which could be scaled to 0 to 10 V) or an digital duty cycle/pulse width modulation (PWM) output that could then be converted to 0 to 10 V or other voltages for this example of a digital, analog or phase detection based on a triac signal.

FIG. 13 depicts an example of a dimming controller 146 or interface that has a phase detection circuit that, for example, depending on the values of the components 154, 156 and 158, can provide an analog output (which could be scaled to 0 to 10 V) or an digital duty cycle/pulse width modulation (PWM) output that could then be converted to 0 to 10 V or other voltages for this example of a digital, analog or phase detection based on a triac signal. Other voltages such as 0 to 5 V, 0 to 2.5 V, 0 to 2 V, 0 to 1 V, etc. can be used besides 0 to 10 V. Time constants and/or filters can be included in various embodiments of the present invention, for example with capacitor 160 or other components placed in suitable locations in the system.

The output converter 152 may comprise, for example, a circuit using passive and/or active electronic elements to scale an output from the converter 134 to provide the desired dimming control signal 148, for example scaling it to a 0 to 10 V signal. In some embodiments, the output converter 152 comprises a microcontroller with an analog to digital converter input and a digital to analog converter output to provide the desired scaling or other processing. In some embodiments, the output converter 152 comprises a microcontroller with a comparator input and a digital to analog converter output. In some embodiments, the output converter 152 comprises a microcontroller with a comparator input and a pulse width modulated output that could be used as a PWM signal or averaged/filtered to produce a DC analog signal.

Dimming can be linear, log, exponential, squared, square-root, power series, etc. of the input signal, etc.

Some of the embodiments of FIGS. 10-13 provide digital, analog or phase detection based on a triac signal with simple time constant to provide an averaged signal where the analog average signal is read as an input to the microcontroller and the microcontroller outputs a voltage from 0 to 10 V that is proportional to the triac input dimming level. Other voltages such as 0 to 5 V, 0 to 2.5 V, 0 to 2 V, 0 to 1 V, etc. can be used besides 0 to 10 V. In some of these, the input signal

is read as an input to the microcontroller and the microcontroller outputs a voltage from 0 to 10 V that is proportional to the triac input dimming level. Averaging and other time constant and filtering can be accomplished by the microcontroller if needed. In addition a microcontroller with analog to digital (ADC) input and digital to analog (DAC) output can be used. Dimming can be linear, log, exponential, squared, square-root, power series, etc. of the input signal, etc. In others of these embodiments, the input signal is read as an input to the microcontroller and the microcontroller outputs a voltage or a pulse width modulation (PWM) signal that is proportional to the triac input dimming level. Averaging and other time constant and filtering can be accomplished by the microcontroller if needed. In yet other embodiments, the input signal can be read as an input to the microcontroller and the microcontroller outputs a pulse width modulation (PWM) signal from 0 to 100% that is averaged/converted to a 0 to 10 V output signal that is proportional to the triac input dimming level. Other voltages such as 0 to 5 V, 0 to 2.5 V, 0 to 2 V, 0 to 1 V, etc. can be used besides 0 to 10 V. In addition a microcontroller with analog to digital (ADC) input and digital to analog (DAC) output can be used. Dimming can be linear, log, exponential, squared, square-root, power series, etc. of the input signal, etc.

Many of the features of the present invention can be can be performed manually, automatically, dynamically, algorithmically, can employ smart and intelligent dimming decisions, artificial intelligence, remote control, remote dimming, human input, voice command/control/smart device (cellular phone, tablet, ipod, etc.) etc.

The present invention allows, for, for example, simultaneous control and dimming of dimmable LED/OLED drivers,

FL/CFL ballasts, power supplies, etc. A mobile device such as a smart phone or tablet or related device (e.g., iPhone, iPad, iPod, Android phone or Android tablet, other smartphones, Kindle, etc.) can be interfaced to the present invention via a diverse number of ways including a web browser (or other method of connectivity including via a cellular phone network, satellite links, cell phone provider, land line provider, cable provider, etc.) via, for example a WiFi enabled controller board that is able to communicate with the various light sources, including, but not limited, to 0 to 10 V (and other voltage range) dimmable drivers, ballasts, power supplies, etc. The present invention can also use and be interfaced/connected to a smart phone, an iPod, a tablet or a computer, etc. to control, monitor, log, etc. A number of communication paths that may be included, such as a powerline, wired and wireless connection. The interface may be adapted to use one or more of these or other communication paths, and is not limited to the example illustrated with three communication paths. Embodiments of the present invention can detect cell phone, smart phone, iPod, iPad, Droid, tablet and other wireless devices, etc. approaching or in the vicinity and use this information to turn on or off and/or dim the lighting.

In addition to dimming by adjusting, for example, a virtual GUI button or buttons, slider or sliders, knobs or knobs, etc. an/or with a physical potentiometer or set of potentiometers, encoders, decoders, etc., the present invention can also support all standards, ways, methods, approaches, techniques, etc. for interfacing, interacting with and supporting, for example, 0 to 10 V dimming with a suitable reference voltage that can be remotely set or set via an analog or digital input such as illustrated in U.S. Patent Application 61/652,033 filed on May 25, 2012, for a “Dimmable LED Driver”, and U.S. Patent Application 61/657,110 filed on Jun. 8, 2012 which are incorporated herein by reference for all purposes. The present invention can also use applications (APPs) either specifically or generally designed for the particular mobile device such as an iPhone, Android phone, Android tablet, iPad, iPod, etc. The present invention can also allow manual and/or automatic firmware and software upgrades to, for example, the mobile device applications, if any, and the controller that interfaces with lighting sources and also the lighting sources themselves and even, for example, the lighting source drivers and internal controllers. Certain embodiments of the present invention can be also monitor, log, store, etc. the states and conditions of the light sources including but not limited to the dimming level, the color combinations/selections/levels/etc., the on-off status and state, the power level, the efficiency, the power factor, the input and output current, voltage and power, etc. The present invention can also be used to and can depend on various inputs and stimuli including, but not limited to, audio (including digital or analog generated music from any source including the iPhone, iPod, iPad, Android phone, Android tablet, etc.), other sounds and vibrations, randomly generated signals, other light sources, smells, tactile and/or touch interfaces, etc.

The present invention can support all standards and conventions for 0 to 10 V dimming or other dimming techniques. In addition the present invention can support, for example, overcurrent, overvoltage, short circuit, and over-temperature protection.

In place of the potentiometer, an encoder or decoder can be used. The use of such also permits digital signals to be used and allows digital signals to either or both locally or remotely control the dimming level and state. A potentiometer with an analog to digital converter (ADC) or converters (ADCs) could also be used in many of such implementations of the present invention.

The inventions disclosed herein are not limited to the example circuits and applications illustrated, and may be adapted to use with, for example but not limited to, the circuits and applications disclosed in U.S. Patent Application 61/664,993 filed Jun. 27, 2012 for an “Interface for Dimmable Drivers”, and in U.S. Patent Application 61/665,876 filed Jun. 28, 2012 for an “Interface for Dimmable Drivers”, which are incorporated herein by reference for all purposes.

Although some of the example embodiments discussed above used comparators, the choice of comparators in these example embodiments should not be construed to be limiting in any way or form; other choices including, but not limited to, op amps, difference amplifiers, difference circuits, etc. can be used with and for the present invention.

FIG. 14 provides a simple block diagram of certain embodiments of the present invention showing some of the various and diverse controls and monitors that can be used and work with the present invention. A triac based dimmer 172 processes an AC input 170, and a control unit 174 controls a dimmable LED driver 176, dimmable FL ballast 178, and/or dimmable power supply 180, etc., based on the output of the triac based dimmer 172. An optional secondary load 182 is provided in some embodiments to assist the triac 172 to trigger correctly. The control unit 174 may also base the control and optional reporting functions on inputs from external signals 184, motions sensor(s) 186, photosensor(s) 188, wireless controls 190, powerline controls 192, wired controls 194, and other analog or digital controls 196, etc.

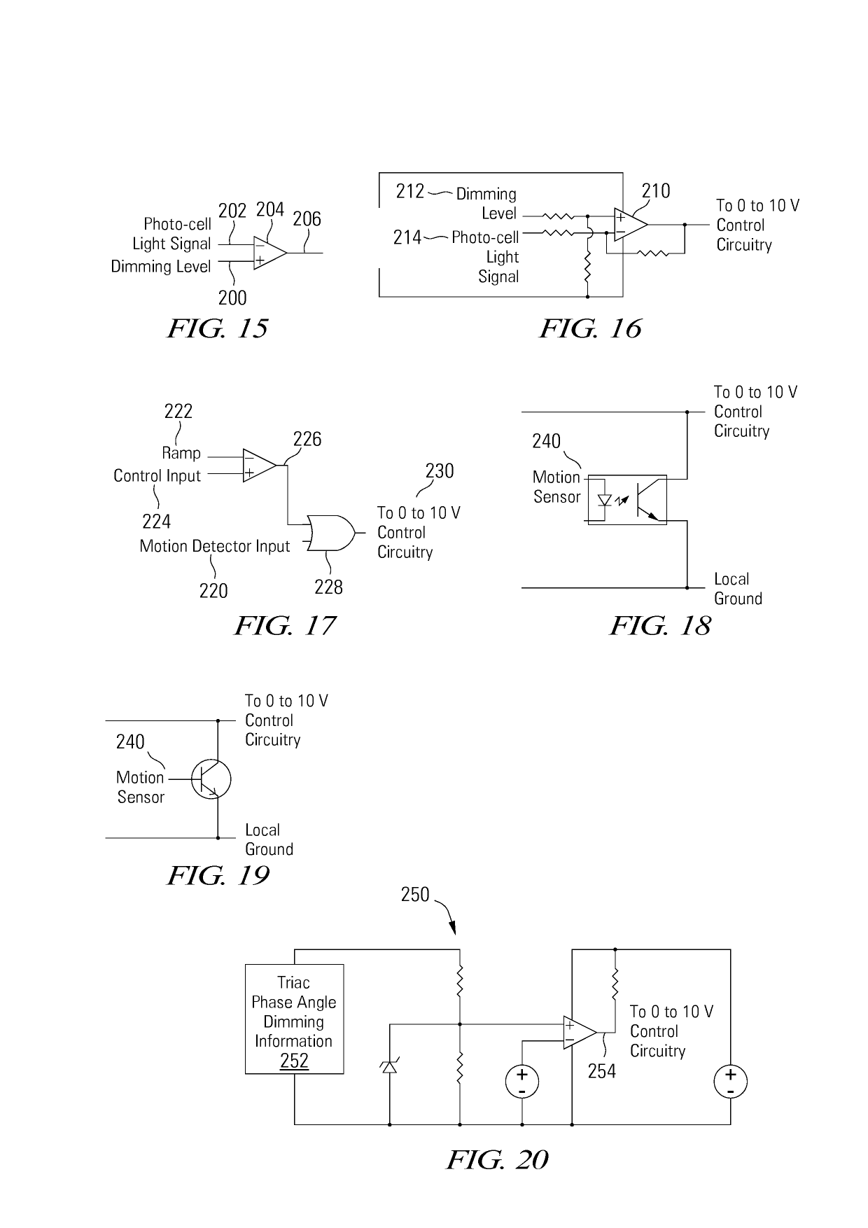

FIG. 15 shows one simple example of an embodiment of a digital control for the photodetector/light dimming control. A dimming level 200 from a control unit (e.g., 174) is compared with a photo-cell light signal 202 from a sensor (e.g., 188) in a comparator 204 or op-amp or other device, yielding an adapted output 206 to be used to control a dimmable driver. Should the light level be below the dimming set point, the light source will be set to the dimming level. Should the photodetector/light level be above the dimming level set point, then the dimmed (or full on) light will be set to turn off. Time constants/filters including variable/adjustable time constants/filters may be used including ones that can be manually adjusted/set by the user and application.

FIG. 16 shows one simple example embodiment of an analog control that uses a difference amplifier 210 to produce the difference between the dimming set level 212 and the photodetector/light level signal 214 and applies this to the control input of, for example, comparator 210 to set the phase angle control of the dimmer.

FIG. 17 shows one simple example embodiment of a motion detector signal 220 that produces a full on response from the present invention. Ramp 222 and Control Input 224 signals are used to generate a dimming control signal 226 normally provided to 0 to 10 V control circuitry 230 or other dimming control circuitry. When the output of the motion detector/sensor 220 goes high, an OR gate 228 input produces a high output provided to 0 to 10 V control circuitry 230 that drives switching transistors to turn on resulting in a full on condition for the load for the duration of the motion detector signal regardless of the state or condition of the dimming signal and/or any photosensor/photodetector input for this particular embodiment of the present invention. Other embodiments can be readily constructed and implemented that permit, for example, the dimming level to be sent by the activation signal from the motion detector using analog, digital and/or pulse width modulation (PWM), etc. approaches, methods and techniques. Other embodiments can allow the photodetector(s)/photosensor(s) signals to set the dimming level and/or override the motion detector signal, etc.

The motion detector/sensor may be powered by any suitable source, such as but not limited to a power source derived from the input voltage to the dimming circuit, or from other sources such as a battery, solar power source, mechanical or thermal power source, etc, or any combination of these, etc. In addition, the sensors, such as, but not limited to, motion, sound, thermal, mechanical, voice activated, motion, light, photodetection, etc., can be remote from the present invention and either powered directly or indirectly by the present invention or remotely powered via battery or batteries, battery charger(s), AC or DC power, wired or wireless power, electrical, mechanical, light, photo, solar cell, photovoltaic, vibrational, RF, inductive, etc. or a combination of these. The above is meant to be illustrative and should not be construed as limiting in any way or form.

Various embodiments of a dimmer with motion and/or light sensing may also incorporate soft start turn on and/or soft start turn off, gradually adjusting the dimming setting in response to motion detection and/or light sensing. The soft start options may further be programmable, configurable or controllable, for example but not limited to by switch selection or by remote configuration commands.

FIG. 18 shows another example of a method to control the on/off/dimming state of the present invention. The partial circuit shown in FIG. 18 can be configured and used to turn off output switching transistors in a dimmable driver by having the output of the optocoupler/optoisolator 240 set to effectively short the gate voltage of output transistors (not shown) in the dimmable driver. By applying a signal either directly or, for example, modified by other circuitry from the motion sensor, the motion detect signal can be used to turn off the input to the opto-coupler/opto-isolator and to allow the current/set dimming level to be applied to the output switching transistors and, therefore, to the connected load.

FIG. 19 shows another example using a transistor 242 controlled by a motion sensor to turn off the dimmable driver and load in the absence of motion. Timers (not shown) may be included to allow current to flow to the load for a given time after motion is no longer detected. Although an NPN BJT is shown in FIG. 19, in general, any type of transistor or vacuum tube or other similarly functioning device can be used including, but not limited to, MOSFETs, JFETs, gallium nitride FETs (GANFETs), silicon carbide FETs (SiCFETs), depletion or enhancement FETs, N and/or P FETs, CMOS, PNP BJTs, triodes, etc. which can be made of any suitable material and configured to function and operate to provide the performance, for example, described above. In addition, other types of devices and components can be used including, but not limited to transformers, transformers of any suitable type and form, coils, level shifters, digital logic, analog circuits, analog and digital, mixed signals, microprocessors, microcontrollers, FPGAs, CLDs, PLDs, comparators, op amps, instrumentation amplifiers, and other analog and digital components, circuits, electronics, systems etc. For all of the example figures shown, the above analog and/or digital components, circuits, electronics, systems etc. are, in general, applicable and usable in and for the present invention.

FIG. 20 depicts a phase detection circuit 250 that detects zero crossings in triac phase angle dimming information 252 from a triac based dimmer, providing the resulting zero phase information at output 254 to drive 0 to 10 V control circuitry or other dimming control circuitry, and further downstream, to control a dimming driver and load.

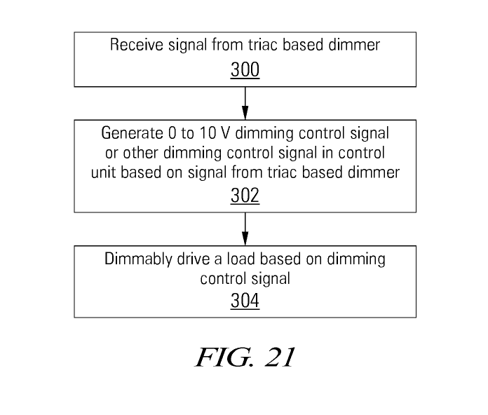

FIG. 21 is a flow chart depicting an operation for dimmably driving a load in accordance with some embodiments of the invention. A signal is received from a triac based dimmer, or other dimming command source. (Block 300) A 0 to 10 V dimming control signal or other dimming control signal is generated in a control unit based on the signal from triac based dimmer. (Block 302) A load is dimmably driven based on the dimming control signal. (Block 304)

For the present invention many of these signals can be applied directly using the interfaces and circuits and approaches described herein.

The example figure and embodiments shown in FIGS. 1 through 21 are merely intended to provide some illustrations of the present inventions and not limiting in any way or form for the present inventions.

Using digital and/or analog designs and/or microcontrollers and /or microprocessors any and all practical combinations of control, sequencing, levels, etc., some examples of which are listed below for the present invention, can be realized.

In addition to the examples illustrated in the figures, a potentiometer or similar device such as a variable resistor may be used to control the dimming level. Such a potentiometer may be connected across a voltage such that the wiper of the potentiometer can swing from minimum voltage (i.e., full dimming) to maximum voltage (i.e., full light). Often the minimum voltage will be zero volts which may correspond to full off and, for the example embodiments shown here, the maximum will be equal to or approximately equal to the voltage on the negative input of the comparator.

Current sense methods including resistors, current transformers, current coils and windings, etc. can be used to measure and monitor the current of the present invention and provide both monitoring and protection.

In addition to dimming by adjusting, for example, a potentiometer, the present invention can also support all standards, ways, methods, approaches, techniques, etc. for interfacing, interacting with and supporting, for example, 0 to 10 V dimming by, for example, a suitable reference voltage that can be remotely set or set via an analog or digital input.

The present invention supports all standards and conventions for 0 to 10 V dimming or other dimming techniques. In addition the present invention can support, for example, overcurrent, overvoltage, short circuit, and over-temperature protection. The present invention can also measure and monitor electrical parameters including, but not limited to, input current, input voltage, power factor, apparent power, real power, inrush current, harmonic distortion, total harmonic distortion, power consumed, watthours (WH) or killowatt hours (kWH), etc. of the load or loads connected to the present invention. In addition, in certain configurations and embodiments, some or all of the output electrical parameters may also be monitored and/or controlled directly for, for example, LED drivers and FL ballasts. Such output parameters can include, but are not limited to, output current, output voltage, output power, duty cycle, PWM, dimming level(s), etc.

In place of the potentiometer, an encoder or decoder can be used. The use of such also permits digital signals to be used and allows digital signals to either or both locally or remotely control the dimming level and state. A potentiometer with an analog to digital converter (ADC) or converters (ADCs) could also be used in many of such implementations of the present invention.

The present invention can be used and configured in numerous and diverse ways including, but not limited to:

As a dimmer with a motion sensor input such that the motion sensor, when motion is detected and the motion sensor is activated, sets the dimmer to full on.

As a dimmer with a motion sensor input such that the motion sensor, when motion is detected and the motion sensor is activated, sets the dimmer to full on output.

As a dimmer with a motion sensor input such that the motion sensor, when motion is detected and the motion sensor is activated, sets the dimmer from the dimming level to full on.

As a dimmer with a motion sensor input such that the motion sensor, when motion is detected and the motion sensor is activated, sets the dimmer from full off to full on.

As a dimmer with a motion sensor input such that the motion sensor, when motion is detected and the motion sensor is activated, sets the dimmer from a minimum dimming level to full on.

As a dimmer with a motion sensor input such that the motion sensor, when motion is detected and the motion sensor is activated, sets the dimmer from a minimum dimming level to the current dimming level.

As a dimmer with a motion sensor input such that the motion sensor, when motion is detected and the motion sensor is activated, sets the dimmer from a minimum dimming level to the set dimming level.

As a dimmer with a motion sensor input such that the motion sensor, when motion is detected and the motion sensor is activated, sets the dimmer from a minimum dimming level to the specified dimming level.

As a dimmer with a motion sensor input such that the motion sensor, when motion is detected and the motion sensor is activated, sets the dimmer from the current dimming level to another dimming level.

As a dimmer with a motion sensor input such that the motion sensor, when motion is detected and the motion sensor is activated, sets the dimmer from the current dimming level to a higher dimming level.

As a dimmer with a motion sensor input such that the motion sensor, when motion is detected and the motion sensor is activated, sets the dimmer from full off to the current dimming level.

As a dimmer with a motion sensor and photosensor/photodetector input such that the motion sensor, when motion is detected and the motion sensor is activated, sets the dimmer from a minimum dimming level to the current dimming level or the dimming level set by the photosensor/photodetector whichever is lower.

As a dimmer with a motion sensor and photosensor/photodetector input such that the motion sensor, when motion is detected and the motion sensor is activated, sets the dimmer from a minimum or full off to the current dimming level or the dimming level set by the photosensor/photodetector.

As a dimmer with a motion sensor and photosensor/photodetector input such that the motion sensor, when motion is detected and the motion sensor is activated, sets the dimmer from a minimum dimming level to the current dimming level or the dimming level set by the photosensor/photodetector.

As a dimmer with a motion sensor and photosensor/photodetector input such that the motion sensor, when motion is detected and the motion sensor is activated, sets the dimmer from full off to the current dimming level or the dimming level set by the photosensor/photodetector.

As a dimmer with a motion sensor and photosensor/photodetector input such that the motion sensor, when motion is detected and the motion sensor is activated, sets the dimmer from the current dimming level or the dimming level set by the photosensor/photodetector to full on.

As a dimmer with a motion sensor and photosensor/photodetector input such that the motion sensor, when motion is detected and the motion sensor is activated, sets the dimmer from the current dimming level or the dimming level set by the photosensor/photodetector to the same or another level of dimming depending on the photodetector signal.

As a dimmer with a motion sensor and photosensor/photodetector input such that the motion sensor, when motion is detected and the motion sensor is activated, ignores the motion sensor depending on the photosensor/photodetector signal.

As a dimmer with a motion sensor and photosensor/photodetector input such that the motion sensor, when motion is detected and the motion sensor is activated, works in conjunction with the photosensor/photodetector to set the output level.

As an on/off switch with a motion sensor and photosensor/photodetector input such that the motion sensor, when motion is detected and the motion sensor is activated, sets the switch from full off to the current dimming level or the dimming level set by the photosensor/photodetector.

As an on/off switch with a motion sensor and photosensor/photodetector input such that the motion sensor, when motion is detected and the motion sensor is activated, sets the switch from full off to full on.

The above examples and figures are merely meant to provide illustrations of the present and should not be construed as limiting in any way or form for the present invention.

In addition to the examples above and any combinations of the above examples, the present invention can have multiple dimming levels set by the dimmer in conjunction with the motion sensor and photosensor/photodetector and/or other control and monitoring inputs including, but not limited to, analog (e.g., 0 to 10 V, 0 to 3 V, etc.), digital (RS232, RS485, USB, DMX, SPI, SPC, UART, other serial interfaces, etc.), a combination of analog and digital, analog-to-digital converters and interfaces, digital-to-analog converters and interfaces, wired, wireless (i.e., RF, WiFi, ZigBee, Zwave, ISM bands, 2.4 GHz, etc.), powerline (PLC) including X-10, Insteon, HomePlug, etc.), etc.

The photocell and/or motion sensor can be powered by any type of source or sources either directly or indirectly from the present invention or independently via wired and/or wireless means, approaches and source(s) and can also use batteries or the likes that can be stand-alone or recharged by any means, methods and approaches. The photocell can provide analog and/or digital signals, information, voltages, etc. The motion sensor can provide analog and/or digital signals, information, voltages, etc.

The present invention is highly configurable and words such as current, set, specified, etc. when referring to, for example, the dimming level or levels, may have similar meanings and intent or may refer to different conditions, situations, etc. For example, in a simple case, the current dimming level may refer to the dimming level set by, for example, a control voltage from a digital or analog source including, but not limited to digital signals, digital to analog converters (DACs), potentiometer(s), encoders, etc.

The present invention can have embodiments and implementations that include manual, automatic, monitored, controlled operations and combinations of these operations. The present invention can have switches, knobs, variable resistors, encoders, decoders, push buttons, scrolling displays, cursors, etc. The present invention can use analog and digital circuits, a combination of analog and digital circuits, microcontrollers and/or microprocessors including, for example, DSP versions, FPGAs, CLDs, ASICs, etc. and associated components including, but not limited to, static, dynamic and/or non-volatile memory, a combination and any combinations of analog and digital, microcontrollers, microprocessors, FPGAs, CLDs, etc. Items such as the motion sensor(s), photodetector(s)/photosensor(s), microcontrollers, microprocessors, controls, displays, knobs, etc. may be internally located and integrated/incorporated into the dimmer or externally located. The switches/switching elements can consist of any type of semiconductor and/or vacuum technology including but not limited to triacs, transistors, vacuum tubes, triodes, diodes or any type and configuration, pentodes, tetrodes, thyristors, silicon controlled rectifiers, diodes, etc. The transistors can be of any type(s) and any material(s)—examples of which are listed below and elsewhere in this document.

The dimming level(s) can be set by any method and combinations of methods including, but not limited to, motion, photodetection/light, sound, vibration, selector/push buttons, rotary switches, potentiometers, resistors, capacitive sensors, touch screens, wired, wireless, PLC interfaces, etc. In addition, both control and monitoring of some or all aspects of the dimming, motion sensing, light detection level, sound, etc. can be performed for and with the present invention.

Other embodiments can use other types of comparators and comparator configurations, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices (CLDs), field programmable gate arrays (FPGAs), etc.

The dimmer for dimmable drivers may use and be configured in continuous conduction mode (CCM), critical conduction mode (CRM), discontinuous conduction mode (DCM), resonant conduction modes, etc., with any type of circuit topology including but not limited to buck, boost, buck-boost, boost-buck, cuk, SEPIC, flyback, forward-converters, etc. The present invention works with both isolated and non-isolated designs including, but not limited to, buck, boost-buck, buck-boost, boost, cuk, SEPIC, flyback and forward-converters. The present invention itself may also be non-isolated or isolated, for example using a tagalong inductor or transformer winding or other isolating techniques, including, but not limited to, transformers including signal, gate, isolation, etc. transformers, optoisolators, optocouplers, etc.

The present invention may include other implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

The present invention can also incorporate at an appropriate location or locations one or more thermistors (i.e., either of a negative temperature coefficient [NTC] or a positive temperature coefficient [PTC]) to provide temperature-based load current limiting.

As an example, when the temperature rises at the selected monitoring point(s), the phase dimming of the present invention can be designed and implemented to drop, for example, by a factor of, for example, two. The output power, no matter where the circuit was originally in the dimming cycle, will also drop/decrease by a some factor. Values other than a factor of two (i.e., 50%) can also be used and are easily implemented in the present invention by, for example, changing components of the example circuits described here for the present invention. As an example, a resistor change would allow and result in a different phase/power decrease than a factor of two. The present invention can be made to have a rather instant more digital-like decrease in output power or a more gradual analog-like decrease, including, for example, a linear decrease in output phase or power once, for example, the temperature or other stimulus/signal(s) trigger/activate this thermal or other signal control.

In other embodiments, other temperature sensors may be used or connected to the circuit in other locations. The present invention also supports external dimming by, for example, an external analog and/or digital signal input. One or more of the embodiments discussed above may be used in practice either combined or separately including having and supporting both 0 to 10 V and digital dimming. The present invention can also have very high power factor. The present invention can also be used to support dimming of a number of circuits, drivers, etc. including in parallel configurations. For example, more than one driver can be put together, grouped together with the present invention. Groupings can be done such that, for example, half of the dimmers are forward dimmers and half of the dimmers are reverse dimmers. Again, the present invention allows easy selection between forward and reverse dimming that can be performed manually, automatically, dynamically, algorithmically, can employ smart and intelligent dimming decisions, artificial intelligence, remote control, remote dimming, etc.

Various embodiments may be used in conjunction with dimming to provide thermal control or other types of control to, for example, a dimming LED driver. Various embodiments may also be adapted to provide overvoltage or overcurrent protection, short circuit protection for, for example, a dimming LED driver, CFL, incandescent bulb, etc., or to override and cut the phase and power to the dimming LED driver(s) based on any arbitrary external signal(s) and/or stimulus. The present invention can also be used for purposes and applications other than lighting—as an example, electrical heating where a heating element or elements are electrically controlled to, for example, maintain the temperature at a location at a certain value. The present invention can also include circuit breakers including solid state circuit breakers and other devices, circuits, systems, etc. that limit or trip in the event of an overload condition/situation. The present invention can also include, for example analog or digital controls including but not limited to wired (i.e., 0 to 10 V, RS 232, RS485, IEEE standards, SPI, I2C, other serial and parallel standards and interfaces, etc.), wireless, powerline, etc. and can be implemented in any part of the circuit for the present invention. The present invention can be used with a buck, a buck-boost, a boost-buck and/or a boost, flyback, or forward-converter design, topology, implementation, etc.

A dimming voltage signal, VDIM, which represents a voltage from, for example but not limited to, a 0-10 V Dimmer can be used with the present invention; when such a VDIM signal is connected, the output as a function time or phase angle (or phase cut) will correspond to the inputted VDIM.

Other embodiments can use comparators, other op amp configurations and circuits, including but not limited to error amplifiers, summing amplifiers, log amplifiers, integrating amplifiers, averaging amplifiers, differentiators and differentiating amplifiers, etc. and/or other digital and analog circuits, microcontrollers, microprocessors, complex logic devices, field programmable gate arrays, etc.

The present invention includes implementations that contain various other control circuits including, but not limited to, linear, square, square-root, power-law, sine, cosine, other trigonometric functions, logarithmic, exponential, cubic, cube root, hyperbolic, etc. in addition to error, difference, summing, integrating, differentiators, etc. type of op amps. In addition, logic, including digital and Boolean logic such as AND, NOT (inverter), OR, Exclusive OR gates, etc., complex logic devices (CLDs), field programmable gate arrays (FPGAs), microcontrollers, microprocessors, application specific integrated circuits (ASICs), etc. can also be used either alone or in combinations including analog and digital combinations for the present invention. The present invention can be incorporated into an integrated circuit, be an integrated circuit, etc.

The present invention can and may also use other types of stimuli, input, detection, feedback, response, etc. including but not limited to motion, music, voice, voice commands, sound, vibration, frequencies above and below the typical human hearing range, temperature, humidity, pressure, light including below the visible (i.e., infrared, IR) and above the visible (i.e., ultraviolet, UV), radio frequency signals, combinations of these, etc. For example, the motion sensor may be replaced or augmented with a sound sensor (including broad, narrow, notch, tuned, tank, etc. frequency response sound sensors) and the light sensor could consist of one or more of the following: visible, IR, UV, etc. sensors. In addition, the light sensor(s)/detector(s) could also be replaced or augmented by thermal detector(s)/sensor(s), etc.

The example embodiments disclosed herein illustrate certain features of the present invention and not limiting in any way, form or function of present invention. The present invention is, likewise, not limited in materials choices including semiconductor materials such as, but not limited to, silicon (Si), silicon carbide (SiC), silicon on insulator (SOI), other silicon combination and alloys such as silicon germanium (SiGe), etc., diamond, graphene, gallium nitride (GaN) and GaN-based materials, gallium arsenide (GaAs) and GaAs-based materials, etc. The present invention can include any type of switching elements including, but not limited to, field effect transistors (FETs) of any type such as metal oxide semiconductor field effect transistors (MOSFETs) including either p-channel or n-channel MOSFETs of any type, junction field effect transistors (JFETs) of any type, metal emitter semiconductor field effect transistors, etc. again, either p-channel or n-channel or both, bipolar junction transistors (BJTs) again, either NPN or PNP or both, heterojunction bipolar transistors (HBTs) of any type, high electron mobility transistors (HEMTs) of any type, unijunction transistors of any type, modulation doped field effect transistors (MODFETs) of any type, etc., again, in general, n-channel or p-channel or both, vacuum tubes including diodes, triodes, tetrodes, pentodes, etc. and any other type of switch, etc.

While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. An apparatus comprising:
a dimming signal input;
a dimming control signal output; and
a dimming control circuit operable to provide a dimming control signal at the dimming control signal output based at least in part on a dimming signal at the dimming signal output, wherein a format of the dimming control signal is different than a format of the dimming signal.

2. The apparatus of claim 1, wherein the dimming signal is selected from a group consisting of a dimming signal generated by a triac based dimmer, a powerline dimming signal, and a wireless dimming signal.

3. The apparatus of claim 1, wherein the dimming control signal comprises a direct current dimming control signal having a voltage range operable to specify a desired dimming level.

4. The apparatus of claim 3, wherein the dimming control signal comprises a 0 to 10 volt dimming control signal.

5. The apparatus of claim 1, wherein the dimming control signal comprises an analog dimming control signal.

6. The apparatus of claim 1, wherein the dimming control signal comprises a digital dimming control signal.

7. The apparatus of claim 1, wherein the dimming control circuit comprises a zero crossing detector operable to detect zero crossings in the dimming signal input and a conversion circuit operable to generate a direct current dimming control signal having a voltage range that specifies a desired dimming level based upon an output of the zero crossing detector.

8. The apparatus of claim 1, further comprising a dimmable driver operable to drive a load output based at least in part upon the dimming control signal.

9. The apparatus of claim 8, wherein the dimmable driver is operable to drive at least one light emitting diode lamp connected to the load output.

10. The apparatus of claim 8, wherein the dimmable driver is operable to drive at least one fluorescent lamp ballast connected to the load output.

11. The apparatus of claim 8, further comprising a second dimmable driver operable to drive a second load output based at least in part upon the dimming control signal.

12. The apparatus of claim 8, further comprising a secondary load connected to the dimming signal input, operable to facilitate triggering in a triac based dimmer that generates the dimming signal.

13. The apparatus of claim 12, wherein the secondary load comprises a variable impedance.

14. The apparatus of claim 1, wherein the dimming control circuit comprises a microcontroller with an analog to digital converter input connected to the dimming signal input and a digital to analog converter output connected to the dimming control signal output.

15. The apparatus of claim 1, wherein the dimming control circuit comprises a microcontroller with a comparator input connected to the dimming signal input and a digital to analog converter output connected to the dimming control signal output.

16. The apparatus of claim 1, wherein the dimming control circuit comprises a microcontroller with a comparator input connected to the dimming signal input and a pulse width modulated output connected to the dimming control signal output.

17. The apparatus of claim 1, further comprising a motion sensor operable to disable the dimming control signal during periods in which no motion has been detected.

18. The apparatus of claim 1, further comprising a photosensor, wherein the dimming control circuit is operable to generate the dimming control signal at least in part on an output of the photosensor.

19. The apparatus of claim 1, further comprising an external control input, wherein the dimming control circuit is operable to generate the dimming control signal at least in part on the external control input.

20. A method of driving a load, comprising:
receiving a signal from a triac-based dimmer;
generating a dimming control signal having a voltage range that specifies a desired dimming level based on the signal from the triac-based dimmer; and
driving the load based on the dimming control signal.
